(19) United States
(12) Patent Application Publication
(10) Pub. No.: US 2013/0147197 A1
(43) Pub. Date: Jun. 13, 2013

(54) Combined Cycle Solar Power Generation

(71) Applicants: Olaf Goebel, Abu Dhabi (AE); Yousif Al Ali, Abu Dhabi (AE)

(72) Inventors: Olaf Goebel, Abu Dhabi (AE); Yousif Al Ali, Abu Dhabi (AE)

(73) Assignee: Abu Dhabi Future Energy Company, Abu Dhabi (AE)

(21) Appl. No.: 13/764,441

(22) Filed: Feb. 11, 2013

Related U.S. Application Data
(63) Continuation of application No. 13/519,111.
(60) Provisional application No. 61/289,966, filed on Dec. 23, 2009.

(51) Int. Cl. F03G 6/04; F02C 1/05; H02K 7/18; F01K 3/00

(52) U.S. Cl. CPC F03G 6/04; F01K 3/00; F02C 1/05; H02K 7/1823
USPC 290/52; 60/641.12; 60/659; 60/670; 60/650

(57) ABSTRACT

Combined cycle solar power generation is achieved using a primary cycle based on a solar receiver, such as a volumetric absorber, in which compressed air is heated by concentrated solar radiation, coupled with a secondary cycle based on a water/steam circuit driven by exhaust gas from the primary cycle. When the primary cycle is inactive, typically at night time, the secondary cycle can be driven by accessing a heat store of liquid or solid heat storage material, such as a molten salt or concrete blocks, which has been heated earlier during day time operation. The water/steam circuit is reconfigurable between first and second switching conditions, wherein in the first switching condition heat is transferred directly or indirectly from the primary cycle to heat the heat storage material, and in the second switching condition stored heat is transferred from the heat storage material to the water/steam circuit in order to generate steam.

### BACKGROUND OF THE INVENTION

The invention relates to combined cycle power generation based on solar power.

Combined cycle power generation may be defined as power generation which employs multiple thermodynamic cycles in series, typically two, although three or more can be combined. We discuss a two-cycle method in the following, since this shows the relevant principles. In the combined cycle, waste heat from the first cycle is used to drive the second, lower temperature, cycle. This approach has inherently higher efficiency, as defined by conversion of energy content of the fuel into electrical energy. Specifically, in the idealized Carnot cycle of a perfect heat engine, efficiency is proportional to the temperature difference between the hot and cold ends of the cycle. A combined cycle is therefore more efficient than a single cycle by virtue of spanning a greater temperature difference.

Combined cycle power generation is now commonly used for gas fired power stations, and is also attractive for concentrated solar power stations.

FIG. 1 of the accompanying drawings is a schematic diagram of a combined cycle concentrated solar power (CSP) plant or station, a prototype of which has been built at the Plataforma Solar de Almeria (PSA) site in Spain. To be more precise, the prototype at the PSA had only the primary circuit. This was to test the solar receiver design. The secondary cycle is based on standard technology, and hence was not included in the test facility. FIG. 1 however shows the full envisaged design with both primary and secondary circuits.

The components of the primary circuit of the combined cycle power block are shown in the left hand part of the figure and those of the secondary circuit in the right hand part. In the following, the primary circuit is described and then the secondary circuit.

A heliostat 10 comprising an array of mirrors 12 directs solar radiation, i.e. sunlight, from the sun 1 to a solar receiver 20 mounted on top of a tower 14, the overall direction of the sunlight being illustrated by the large arrows 2 and 3. In the real prototype at PSA, the tower 14 is surrounded by a large number of heliostats 10 to concentrate the solar radiation on the solar receiver 20. Only one is shown in the schematic drawing of FIG. 1. Air is taken from the atmosphere, i.e. at ambient temperature and pressure, and supplied through a line 22 to a compressor 24 which compresses the air and passes it to the solar receiver 20 through a line 16. The solar receiver 20 is a volumetric pressurized gas receiver the design of which is described below with reference to FIG. 2.

FIG. 2 is a schematic section of the volumetric pressurized gas receiver 20 which is contained in a casing 210. Air is input into the solar receiver 20 through inlet passageways 202 (from line 16 shown in FIG. 1) and passes into a volumetric absorber 212 which is made of a ceramic heat absorbent material and is porous to allow the passage of air through it. The volumetric absorber 212 is arranged on the inside of a glass window 208 through which the concentrated solar radiation passes and is absorbed by the volumetric absorber 212 which is thereby heated. The window 208 is made of crystal glass, is concave in shape and is arranged to face the heliostat field. The air from the inlet 202 is thus heated during its passage through the volumetric absorber, and then passes to an outlet passage 204 to line 18 of FIG. 1. Insulating material 206 is provided between casing 210, inlet passageways and outlet passageways. This type of solar receiver is called “volumetric” because the energy of the solar radiation is absorbed in the (volume) of the receiver rather than at the outside wall. The receiver is called “pressurized” because the medium which is absorbing the solar heat is air under pressure flowing through the receiver. Further detail of the volumetric pressurized gas receiver can be found in Heller et al.

Returning now to FIG. 1, the heated and pressurized air passes through line 18 to a turbine 28 which is arranged on a shaft 26 common to the compressor 24. Driven by the work performed by the gas, the turbine 28 drives a generator 30, i.e. the primary cycle generator, to produce electricity.

The exhaust gas leaving the gas turbine 28 is still very hot (between 500 and 600° C.). The gas is fed through a line 32 to a boiler 36—usually referred to as a Heat Recovery Steam Generator (HRSG)—where the exhaust gas gives away its heat for producing high pressure steam in a heat exchanger 38. The exhaust gas is then vented to the atmosphere as shown by arrow 40. The heat exchanger 38 receives water through a line 72. The water is converted to steam in the boiler 36 which then passes through line 50 to a steam turbine 52 connected to a generator 56 via a shaft 54. The exhaust steam from the steam turbine 52 passes through a line 58 to a condenser 60. In the condenser 60 the exhaust steam is liquefied to water by action of a heat exchanger 60 having input and output lines 66 and 64 respectively to a heat sink 62. The water from the condenser 60 is then supplied through a line 68 to a feed water pump 70 which pumps the water back to the heat exchanger 38 to complete the description of the secondary cycle.

As can be seen from FIG. 1, the solar receiver is arranged in the position of the combustion chamber of a conventional gas turbine. Because of this similarity, the CSP design of FIG. 1 can, if desired, be easily hybridized by integrating a gas fired burner, most conveniently after the solar receiver, to heat up the gas in case there is no sunshine, e.g. at night.

This comment follows from an obvious limitation of all solar plants—in their basic form—which is that they do not generate electricity after sunset. This is not such an acute problem in regions where electricity demand is dominated by, or at least is strongly correlated with, demand for air conditioning, since the power consumption of air conditioning units will essentially follow the sunshine intensity. This is true in the southern parts of the United States. On the other hand, in some very hot countries energy demand peaks in the evening after sunset. This is true for some countries in Arabia.

The ability of a power plant to deliver electricity on demand is commonly referred to as “dispatchability” which is clearly desirable to any utility company contracting to purchase electricity from the power generation company.

To be “dispatchable”, a CSP plant of the kind shown in FIG. 1 can easily be hybridized by providing a gas burner in the primary cycle as already mentioned. However, since a CSP plant will often have been built to avoid carbon dioxide emissions, use of an auxiliary gas burner is generally not favored. Even if one is included, the extent of its use should be limited. There may additionally be statutory or contractual penalties which preclude or limit the use of a hybrid approach. Another option is to integrate some form of heat storage to retain heat energy generated during the day time for at least a few hours after sunset, so that the power plant can deliver power on demand.

Various designs have been proposed which integrate a heat store in a concentrated solar power plant of the kind shown in FIG. 1. The known designs integrate a heat store between the solar receiver and the gas turbine. An overview of these is given by Herrmann et al and some are also disclosed in Aringhoff et at. The thermal storage options considered include: stones, ceramic blocks, concrete blocks, mineral oil, solid salt, and liquid salt.

However, integrating thermal storage in a CSP plant of the kind shown in FIG. 1 in a commercially viable way has proven difficult for two reasons.

Firstly, the heat needs to be transferred from the gas (air) to a solid medium (e.g. concrete, stones or a ceramic block structure) during charging, and then from the solid medium back to air during discharging. Heat transfer between solid surfaces and air is generally not very efficient, so that high temperature losses occur. In this respect it is noted that it is not possible to consider use of a liquid for heat storage in view of the very high temperatures, e.g. 1300-1400° C., which would make containment of a liquid impossible, even if a suitable liquid could be found. (This is different from a parabolic solar power plant which operates at lower temperatures and can therefore use liquid storage materials, such as oil or liquid salt.)

Secondly, the heat storage elements need to be in a pressurized container because the hot gas which leaves the solar receiver is under pressure. A thermal energy store which could enable the plant to run for several hours would require a significant mass and hence volume of storage material to be provided. A storage tank suitable for containing the storage material would need to be a pressure vessel, and this vessel would be very large because of the volume needed. While technically possible, when such a system is priced using the market price of steel, it becomes clear that the cost of a pressurized thermal storage vessel would be prohibitive.

### SUMMARY OF THE INVENTION

The solution of the invention is to place the thermal energy storage, not between the solar receiver and the gas turbine in the primary cycle, but rather in the secondary steam-based cycle. This makes it possible to use a non-pressurized system for the heat storage medium which is by far cheaper. A preferred solution is to use molten salt as the heat storage medium. Molten salt is a medium that has been extensively investigated and used as a heat storage medium in parabolic trough solar power plants (see Herrmann et al and Aringhoff et al), and this existing technology can be applied here. By positioning the heat storage medium in the secondary cycle, the heat exchange relevant for the heat storage (and later release) can be made much more efficient than between air and a solid medium. This better heat transfer efficiency leads to a higher overall thermodynamic efficiency during charge and discharge of the stored heat energy.

However, it is noted that the invention includes an inherent compromise, since the thermal storage has been integrated in the less powerful second stage of the combined cycle, not the first stage, which is the stage on which previous design effort on heat storage have been focused. This means that a plant according to the invention will have a lower capacity when running on stored energy (i.e. at night) compared to when it is running directly on solar energy (i.e. during the day).

More specifically, the invention provides a combined cycle power plant based on a primary cycle and a secondary cycle, the primary cycle comprising:
a) a compressor having a gas inlet and being operable to compress the gas received from the gas inlet;
b) a solar receiver arranged to receive compressed gas from the compressor as well as concentrated solar radiation, the solar receiver comprising a gas passageway through which the compressed gas is passed and which is in thermal communication with the concentrated solar radiation, thereby to heat the gas; and
c) a gas turbine through which the heated gas is expanded to generate electricity;
   the secondary cycle based on a water/steam circuit in which is arranged:
d) a heat recovery steam generator having a heat exchanger arranged to generate steam from the heated expanded gas from the primary cycle output from the gas turbine;
e) a steam turbine through which steam is expanded to generate electricity;
f) a condenser for condensing steam from the steam turbine; and
g) a heat storage circuit including a heat storage material, the heat storage circuit being reconfigurable between first and second switching conditions, wherein in the first switching condition heat is transferable from the primary cycle to heat the heat storage material, and in the second switching condition heat is transferable from the heat storage material to the water/steam circuit in order to generate steam.

A heliostat may be arranged to concentrate solar radiation onto the solar receiver, and will comprise mirrors controlled to track the motion of the sun. The heliostat is preferably of the North field type (South field in the Southern hemisphere), since a pressurized volumetric receiver of conventional design is directional with a finite acceptance angle. Alternatively, the heliostat could be a heliostat array distributed in all-around field if the solar receiver were isotropic. For example, multiple radially distributed pressurized volumetric receivers could be provided.

The heat storage material may be a sensible heat medium in solid or liquid form, or a latent heat medium that is switched between different phases, such as solid and liquid, or a chemical heat medium based on reversible reactions. In some embodiments, solid blocks may be arranged in thermal communication with the heat storage circuit in other embodiments a liquid may be used contained in the heat storage circuit.

A liquid heat storage material circuit can be implemented with a cold storage tank and a hot storage tank, wherein in the first switching condition liquid heat storage material passes from the cold storage tank to the hot storage tank, and in the second switching condition liquid heat storage material passes from the hot storage tank to the cold storage tank. It will be appreciated that multiple cold tanks or multiple hot tanks may be used.

As an alternative to separate hot and cold tanks, a thermocline tank or tanks can be used. Namely, the liquid heat storage material circuit further comprises a thermocline storage tank having a hot end and a cold end, wherein in the first switching condition liquid heat storage material is taken from the cold end of the storage tank and returned to the hot end of the storage tank, and in the second switching condition liquid heat storage material is taken from the hot end of the storage tank and is returned to the cold end of the storage tank.

To hybridize the power plant, an auxiliary fossil fuel burner can be arranged in the primary cycle to heat and compress the gas as an alternative to the solar receiver, thereby providing a hybrid primary cycle.

The generating power of the gas turbine is typically larger than the generating power of the steam turbine, since there is more energy conversion in the primary cycle than in the secondary cycle, the ratio of power generation capacity being approximately 2:1, wherein approximately may be defined as the ratio being between 1.5:1 and 2.5:1, more especially 1.8:1 to 2.2:1.

The solar receiver is preferably a volumetric absorber arranged to receive the concentrated solar radiation and in thermal communication with the gas passageway.

A suitable liquid heat storage material comprises a molten salt, for example may consist solely of a molten salt, or be a molten salt mixed with a filler material. Alternatively an oil could be used, such as oils known to be used in plants based on parabolic trough collectors, for example a mineral oil or a synthetic oil.

In one embodiment, the heat storage material is heated by steam in the secondary cycle, so although heat from the gas in the primary cycle drives the heating of the storage material it is done indirectly via steam in the secondary cycle. Namely, the heat storage material circuit comprises a heat exchanger which in the first switching condition provides thermal contact between the heat storage material and steam in the secondary cycle, thereby to heat the heat storage material. This design is suitable for both liquid and solid forms of heat storage material.

In another embodiment the heat storage material is heated by gas from the primary cycle, i.e. the storage material is heated by direct heat exchange with the gas from the primary cycle. This design is suitable for liquid heat storage materials. The heat storage material circuit comprises a heat exchanger which in the first switching condition provides thermal contact between the heat storage material and hot gas from the primary cycle, thereby to heat the liquid heat storage material.

The invention also provides a combined cycle method of generating electricity utilizing a first thermodynamic cycle operating in a first temperature range in combination with a second thermodynamic cycle operating in a second temperature range lower than the first temperature range, wherein the first thermodynamic cycle is based on:
a) directing solar radiation onto a solar receiver;
b) supplying compressed gas to the solar receiver to heat the gas; and
c) expanding the heated gas to generate electricity;
   wherein the second thermodynamic cycle is based on:
d) heating steam;
e) expanding the steam to generate electricity;
f) passing the steam through a condenser to liquefy it into water;
g) supplying the water onward for re-heating info steam;
   having a first mode of use to be operated during periods when the first thermodynamic cycle is active comprising:
i. heating the water in the second thermodynamic cycle into steam using the expanded gas from the first thermodynamic cycle so that the first thermodynamic cycle drives the second thermodynamic cycle; and
ii. heating a heat storage material using either steam from the second thermodynamic cycle, or gas from the first thermodynamic cycle, and then retaining the heated heat storage material for later use;
   and a second mode of use to be operated during periods when the first thermodynamic cycle is inactive comprising:
iii. heating the steam using the heat storage material that was heated in the first mode of use, thereby to drive the second thermodynamic cycle when the first thermodynamic cycle is inactive.

An auxiliary fossil fuel burner may be operated as an alternative heat source to drive the first thermodynamic cycle at times when there is no solar energy available, and steps a), b) and c) are substituted with:
a′) combusting fossil fuel in a burner;
b′) using heat from the burner to heat compressed gas; and
c′) expanding the heated gas to generate electricity.

### BRIEF DESCRIPTION OF THE DRAWINGS

The invention is now described by way of example only with reference to the following drawings.

FIG. 1 is a schematic diagram of a combined cycle concentrated solar power station according to the prior art.

FIG. 2 is a schematic section of a prior ad volumetric pressurized gas receiver as used in the power station of FIG. 1.

FIG. 3 is a schematic diagram of a combined cycle concentrated solar power station according to a first embodiment of the invention as configured for day time use.

FIG. 4 shows the power station of FIG. 3 configured for night time use.

FIG. 5 is a schematic diagram of a combined cycle concentrated solar power station according to a second embodiment of the invention as configured for day time use.

FIG. 6 shows the power station of FIG. 3 configured for night time use.

FIG. 7 is a schematic diagram of a hybrid combined cycle concentrated solar power station according to a third embodiment of the invention.

FIG. 8 is a schematic diagram of a combined cycle concentrated solar power station according to a fourth embodiment of the invention as configured for day time use.

FIG. 9 shows the power station of FIG. 8 configured for night time use.

### DETAILED DESCRIPTION

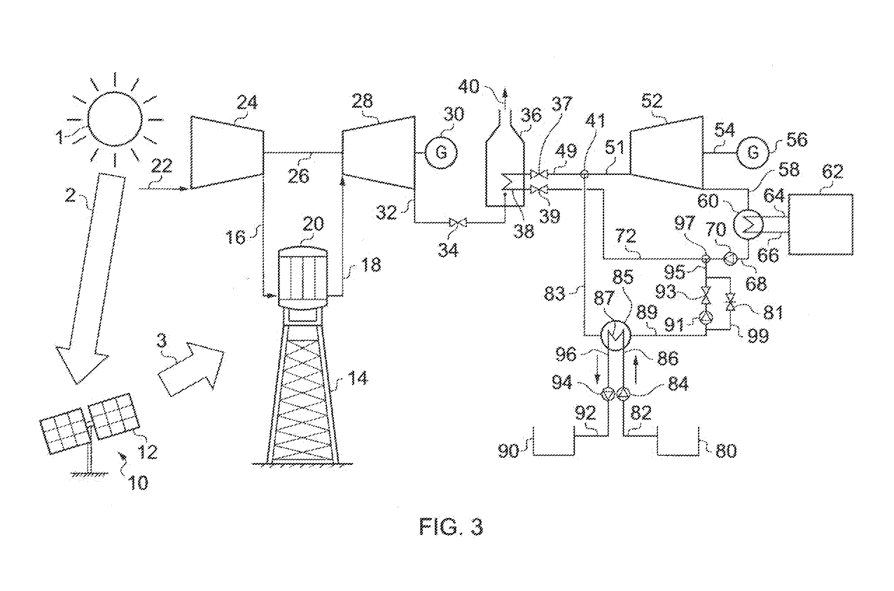

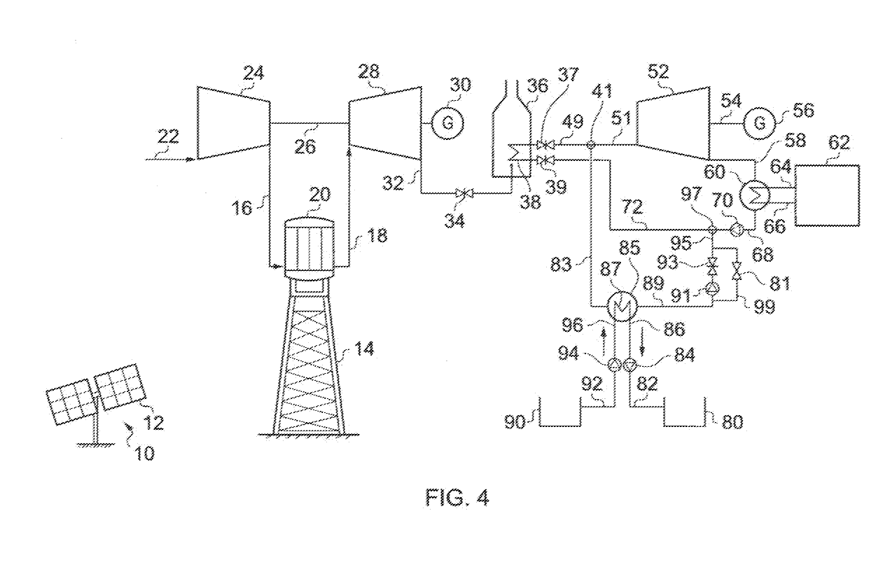

FIGS. 3 and 4 are schematic diagram of a combined cycle concentrated solar power station according to a first embodiment of the invention. FIG. 3 shows the power station configured for day time use. FIG. 4 shows the power station configured for night time use.

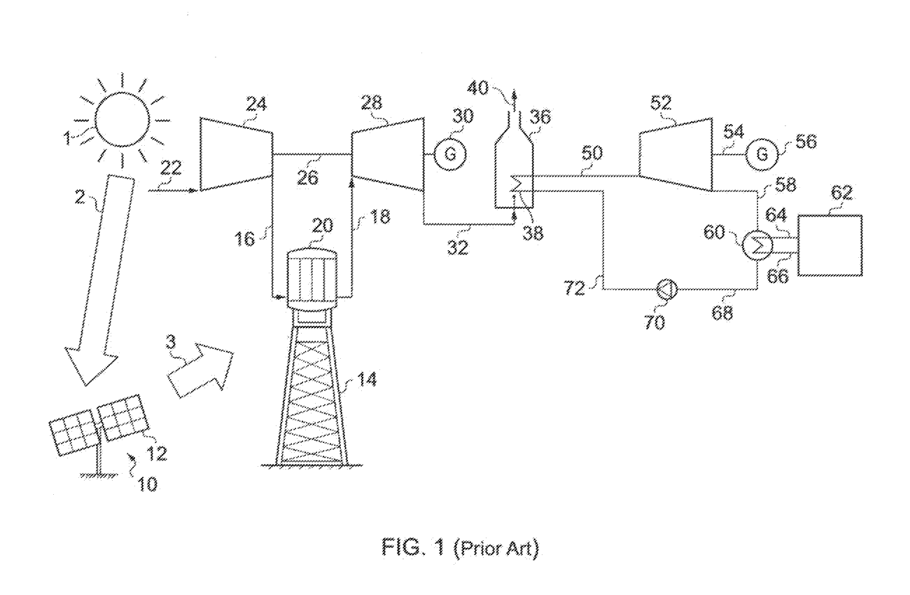

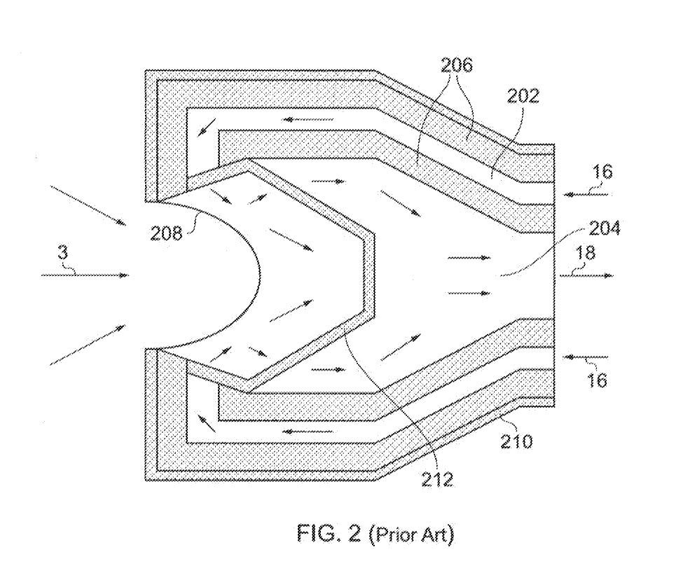

The primary cycle is almost the same as described with reference to FIGS. 1 and 2. Namely, a heliostat 10 comprising an array of mirrors 12 directs solar radiation, i.e. sunlight, from the sun 1 to a solar receiver 20 mounted on top of a tower 14, the overall direction of the sunlight being illustrated by the large arrows 2 and 3. Only one heliostat 10 is shown, but it will be appreciated that an array is provided. Air is taken from the atmosphere, i.e. at ambient temperature and pressure, and supplied through a line 22 to a compressor 24 which compresses the air and passes it to the solar receiver 20 through a line 16. The solar receiver 20 is a volumetric pressurized gas receiver the design of which has been described above with reference to FIG. 2. The heated and pressurized air passes through line 18 to a turbine 28 which is arranged on a shaft 26 common to the compressor 24. Driven by the work performed by the gas, the turbine 28 drives a generator 30, i.e. the primary cycle generator, to produce electricity.

The exhaust gas leaving the gas turbine 28 is still very hot (between 800 and 600° C.). The gas is fed through a line 32 to a boiler 36. The line 32 has an in-line valve 34 which can be closed to stop flow through the line 32. The valve is in the open position in FIG. 3, which is the position for day time use.

In the boiler 36, the exhaust gas from the primary cycle gives away heat to generate high pressure steam in a heat exchanger 38 which is part of the secondary cycle. The exhaust gas is then vented to the atmosphere as shown by arrow 40.

The heat exchanger 38 receives water through a line 72 which is converted to steam in the heat exchanger 38 of boiler 36. The steam then passes through line 49, 51 to a steam turbine 52 connected to a generator 56 via a shaft 54. The exhaust steam from the steam turbine 52 passes through a line 58 to a condenser 60. In the condenser 60 the exhaust steam is liquefied to water by action of a heat exchanger 60 having input and output lines 66 and 64 respectively to a heat sink 62. The water from the condenser 60 is then supplied through a line 68 to a feed water pump 70 which pumps the water back to the heat exchanger 38 to complete the loop.

Thus far the description of the secondary cycle is common with that of the design of FIG. 1. The description now moves to the design aspects that are not present in the design of FIG. 1.

A valve 37 is arranged in the line 37 from the hot, output end of the heat exchanger 38 to the steam turbine 52. The valve 37 is open for day time use as illustrated in FIG. 3. Another valve 39 is arranged in the line 72 from the feed water pump 70 to the cold, input end of the heat exchanger 38. The valve 39 is open for day time use as illustrated in FIG. 3.

Further additional components of the design of the secondary cycle relate to a parallel path to a heat store. During day time operation, a proportion of the steam from the secondary cycle is taken to heat a storage material, which is then stored for night time use. During night time operation, heat is removed from the heat storage material to generate steam to power the turbine and generator, since the primary cycle will be shut down.

The storage material is a liquid, most preferably a molten salt, stored in tanks. One tank is used as a cold tank, and another as a hot tank. As illustrated, during day time operation, salt from a cold tank 80 is pumped by a pump 84 through lines 82 and 86 to a heat exchanger 87 of a condenser 85 where the salt is heated by steam from the secondary cycle and then passes through lines 96 and 92 assisted by a further pump 94 to a hot tank 90, where the heated molten salt is stored. The heat exchanger 87 is arranged in a branch of the secondary cycle. Namely, steam is tapped off the line 49, 51 between the valve 37 and the steam turbine 52 by arranging a junction 41 with spur line 83 to the condenser 85. The spur line then continues along a line 89 to carry the condensed water which is pumped by a pump 91 through a valve 93, which is in the open position during day time use as illustrated in FIG. 3, along a line 95 to a junction 97 where it rejoins the water in the return path 72 from the condenser 60. There is also a line 99 arranged in parallel with the pump 91 and valve 93 to bypass these latter components. The line 99 has a valve 81 therein, which is illustrated in the closed position in FIG. 3, which is its position during day time use. During day time use, this bypass path 99 is therefore not part of the flow path.

It will be appreciated that once all the molten salt has been heated by pumping it from the cold tank 80 to the hot tank 90 via the heat exchanger 87, the pumps 84, 94 and 91 can be switched off and optionally valve 93 closed. Moreover, it will be appreciated that the heating of the storage material can be carried out at some convenient time during the day, for example to take place during a period of lower electricity demand. Further valves (not illustrated) could be provided at junctions 41 and 97 to fully isolate the heat storage/release spur.

FIG. 4 is now referred to to discuss operation after sunset. All the same components shown in FIG. 3 are evident in FIG. 4. However, now there is no sun light and hence the primary cycle has no power. The valve 34 at the end of the primary cycle is closed, as illustrated in FIG. 4. Moreover, the valves 37 and 39 at the input and output sides of the heat exchanger 38 are also closed, as illustrated. Moreover, valve 93 is closed and valve 81 is opened. These valve positions serve to close off the inactive primary cycle from the secondary cycle and to place the secondary cycle in a condition suitable for being driven by the heat stored in the heat storage material.

Water pump 70 pumps water through lines 95, 99 and 89 to unit 85 which is now operating as a boiler (instead of a condenser). The water is heated to steam by the molten salt which is being pumped from the hot tank 90 to the cold tank 80 through lines 92, 96, 87 (the heat exchanger), 86 and 82 assisted by the pumps 94 and 84. The steam then passes through lines 83 and 51 to the steam turbine 52 which drives the generator 56 through the shaft 54. The exhaust steam from the turbine 52 then passes through the line 58 to the condenser 60 where it condenses to water and is passed along line 68 back to the water pump 70 to complete the description of a full loop.

Operation of the plant of the first embodiment thus provides a combined cycle method of generating electricity utilizing a primary or first thermodynamic cycle in combination with a secondary or second thermodynamic cycle. The first thermodynamic cycle operates at a first temperature range and the second thermodynamic cycle operates in a second, lower temperature range, with the ranges coming closest where the two cycles interact, which may involve the lower end of the primary cycle temperature range touching, partially overlapping, or being separated by a temperature gap, from the upper end of the secondary cycle temperature range.

The first thermodynamic cycle is based on: (a) directing solar radiation 2, 3 onto the solar receiver 20; (b) supplying compressed gas, typically air or one of the principal components of air such as nitrogen, to the solar receiver 20 to heat the gas; and (c) expanding the heated gas to generate electricity via the turbine 28.

The second thermodynamic cycle is based on: (d) heating steam; (e) expanding the steam to generate electricity via the turbine 52; (f) passing the steam through a condenser 60 to liquefy it into water; end (g) supplying the water onward for re-heating into steam.

The second thermodynamic cycle has a first mode of use to be operated during periods when the first thermodynamic cycle is active. This will typically be during the day when there is sunlight, but would also include a situation in which the primary cycle is hybridized with an auxiliary heat source, for example by providing a gas burner in parallel with or serial to the solar receiver, and the auxiliary heat source is in operation.

The first mode of use involves: (i) heating the steam using the expanded, exhaust gas from the first thermodynamic cycle so that the first thermodynamic cycle drives the second thermodynamic cycle; and (ii) heating molten salt using either the heated steam or the expanded gas from the first thermodynamic cycle, and then storing the heated molten salt for later use.

The second thermodynamic cycle also has a second mode of use to be operated during periods when the first thermodynamic cycle is inactive. The second mode comprises: (iii) heating the steam using the molten salt that was heated in the first mode of use, thereby to drive the second thermodynamic cycle when the first thermodynamic cycle is inactive.

Some particular temperatures, pressures and suitable molten salts are now stated by way of example only.

In step a) the gas is compressed typically from atmospheric pressure to a pressure of between 5 and 15 bar (=0.5 and 1.5 MPa). The resulting temperature can be calculated assuming isantropic compression.

In step b) the gas is heated to at least 900° C. typically between 900 and 1500° C., most preferably between 1000 and 1400° C. Generally higher temperatures will lead to higher efficiencies, as will be understood from the Carnot cycle which teaches that the maximum efficiency of a thermodynamic cycle is proportional to the maximum temperature less the minimum temperature divided by the maximum temperature. On the other hand, it becomes increasingly demanding to attain higher temperatures owing to materials properties and other design considerations, such as how well the solar radiation can be concentrated. Current technology allows gas to be heated up to around 1400° C. in the pressurized volumetric receiver, but a gradual increase in this temperature is likely to be achieved through incremental improvements in the technology.

In step c) the gas is expanded and cooled in the gas turbine (i.e. expander) to a temperature of typically 400 to 700° C. more especially 500 to 800° C. Typical pressures are atmospheric pressure.

The temperature range at the hot end of the second thermodynamic cycle may be between 500 and 600° C. at the heat recovery steam generator (HRSG) 36, and between 500 and 580° C. in the hot molten salt tank 90. The cold molten salt in the cold tank 80 needs to be kept above its freezing point, which is around 230° C. in the case of a typical mixture of calcium nitrate, sodium nitrate and potassium nitrate—i.e. KNO₃—NaNO₃—Ca(NO₃)₂. In this case, the “cold” salt would be kept at around 250 to 280° C., i.e. approximately 20 to 50° C. above the freezing point. Generally, it will be desirable to keep a molten salt approximately 20 to 50° C. above its freezing point. The expanded steam exhausted from the steam turbine 52 will typically be in the temperature range 6 to 60° C. depending on the ambient temperature. Desirably this temperature is as low as possible for maximum efficiency. A usual temperature would be around 10° C. above ambient. Further detail on suitable molten salts, including optional filler materials, can be found in Brosseau et al.

Typical pressures at the various points in the second thermodynamic cycle are 80-150 bar (8-15 MPa). At the steam turbine inlet and the steam turbine exit, the pressure is dictated by the condensing pressure which is a function of the temperature in the condenser (see above).

The gas used in the primary cycle is most conveniently air, with the air supplied to the volumetric absorber being taken from the atmosphere by the compressor. Any inert gas would also be suitable, for example nitrogen N₂ or carbon dioxide CO₂.

The volume of storage material is chosen having regard to the needs of the off-taking utility company and will preferably be sufficient to drive the secondary cycle for at least a few hours when heated. The maximum run time of the secondary cycle using the heat storage source may range from 1, 2, 3, 4, 5, 6 or 7 hours up to 8, 9, 10, 11, 12, 13, 14, 15, 16, 17 or 18 hours, where the higher numbers would allow for operation at all times, i.e. through the night, depending on latitude and season.

The amount of storage material is set by the off-taker's specification of how many full load hours of operation are required after sunset. That gives the number of kWh that are needed. Dividing that by the thermal to electrical efficiency of the power block gives the number of kWh required. The resultant basic equation can then be used to calculate the mass of storage material required: thermal capacity=Mass*cp*temperature difference, where cp is the specific heat capacity of the storage medium

When molten salt is used as the heat storage material it is possible to use essentially only molten salt, or the storage liquid may additionally be charged with a filling material, such as sand, i.e. SiO₂, or crushed rock, e.g. quartzite, or concrete to act as a heat store. The filling material will typically be confined to the storage tank or tanks with the molten salt circulating.

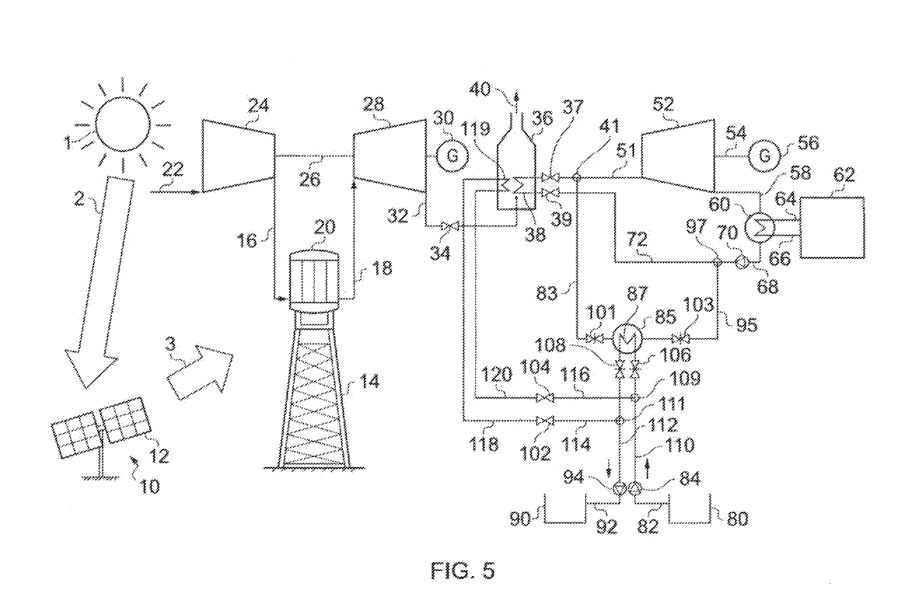

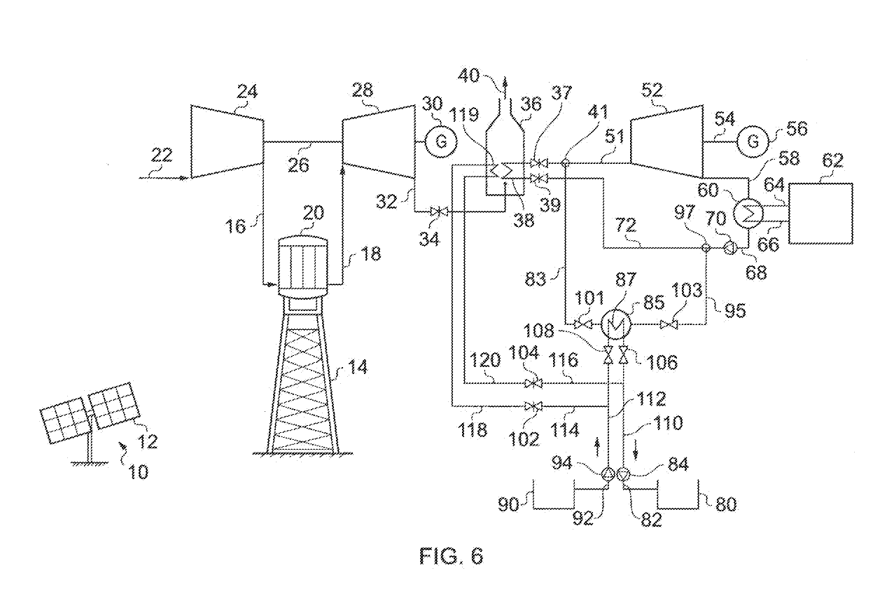

FIG. 5 is a schematic diagram of a combined cycle concentrated solar power station according to a second embodiment of the invention as configured for day time use. FIG. 6 shows the power station of FIG. 4 configured for night time use.

The primary cycle design of the second embodiment is the same as that of the first embodiment, so is net described again. The same reference numerals are also used.

The second embodiment differs from the first embodiment in that the heat storage material is heated directly from the exhaust gas of the primary cycle rather than via the steam in the secondary cycle. Many of the common components of the secondary cycle between the first and second embodiments will be recognized and the same reference numerals are used for common components.

Charging of the heat storage material proceeds as follows. Molten salt is pumped from a cold tank 80 to a hot tank 90 via a heat exchanger 119 housed in a boiler 36. The boiler thus has two heat exchangers, one for the steam in the secondary cycle—heat exchanger 38—and another for heating the molten salt—heat exchanger 119. The path taken by the molten salt from cold tank 80 to hot tank 90 is as follows: line 82, pump 84, line 110 which bifurcates at junction 109, allowing the molten salt to flow to spur line 116, since the other path from the junction is closed by a valve 106 being in the closed position. The molten salt then flows through valve 104, which is open, via line 120 to the cold side of the heat exchanger 119 and then from the hot side to line 118, through valve 102 (which is open), line 114, junction 111, line 112, pump 94, and line 92 to reach the hot tank 90.

As in the first embodiment, it will be appreciated that the heating of the storage material can be carried out at some convenient time during the day, for example to take place during a period of lower electricity demand. During the day time, before or after charging of the heat storage material, valves 102 and 104 may be closed and pumps 84 and 94 deactivated.

FIG. 6 is now referred to to describe the remaining components of the secondary cycle, namely the ones active during night time operation when the secondary cycle is driven by extraction of heat from the heat storage material.

During night time operation, the molten salt charging circuit is isolated by closing valves 102 and 104 as illustrated. Valve 34 from the primary cycle is also closed as illustrated, as are valves 37 and 39. The closure of these valves is all consistent with the fact that the boiler 38 is inactive. Valves 101, 103, 106 and 108 are opened to allow the flow path of steam/water past the heat exchanger 85 and to allow the flow of molten salt from the hot tank 90 to the cold tank 80 via the heat exchanger 85. Steam turbine 52 is driven by steam generated by heat from the molten salt which heats water to steam in the heat exchanger 85. Namely water is pumped by pump 70 via junction 97 and line 95, through open valve 103 to the heat exchanger tubes 87 in the heat exchanger 85. The steam is then conveyed through open valve 101, line 83, junction 41 and line 51 to the steam turbine 52. The steam does work on the turbine 52 to drive shaft 54 and generate electricity in generator 56. The exhaust steam from the turbine 52 is passed through a line 58 to a condenser 60 where it is condensed to water and passes through line 68 back to pump 70 to complete the loop.

The molten salt used to drive the steam generation is pumped from the hot tank 90 to the cold tank 80 through line 92, pump 94, line 112, through open valve 108, passed heat exchanger 87 and then back through open valve 106, line 110, pump 84 and line 82 to cold tank 80.

The example temperatures, pressures and molten salts discussed above in relation to the first embodiment are also applicable to the second embodiment.

As can be seen from FIGS. 3 to 6, the solar receiver is arranged in the position of the combustion chamber of a conventional gas turbine. Because of this similarity, the CSP design can, if desired, be easily hybridized by integrating a gas fired burner, most conveniently after the solar receiver, to heat up the gas in case there is no sunshine, e.g. at night.

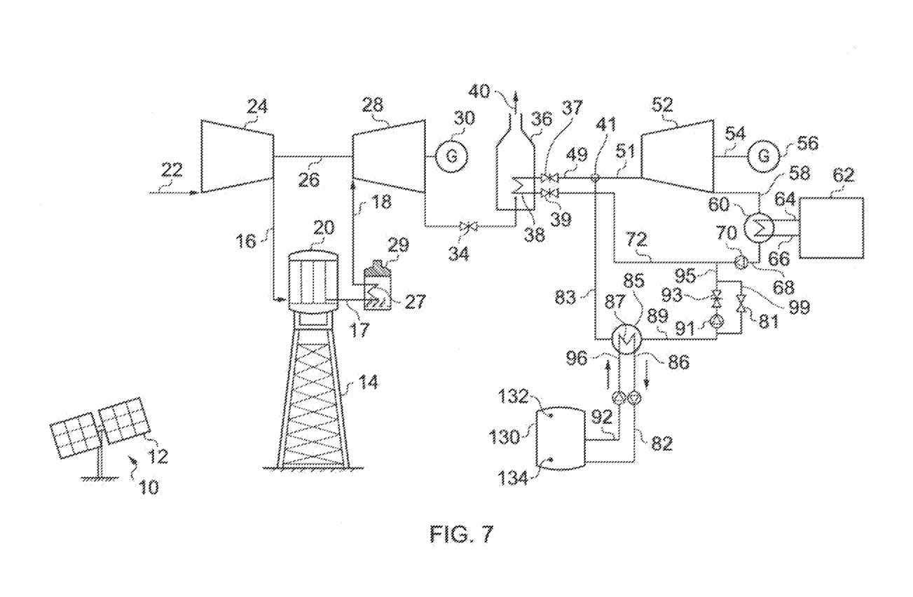

FIG. 7 is a schematic diagram of a hybrid combined cycle concentrated solar power station according to a third embodiment of the invention as configured when the secondary cycle is being driven from the heat store.

The third embodiment is essentially similar to the first embodiment, but incorporates two independent design alterations. The second embodiment could also be modified to incorporate one or both of these design options

The first alteration is addition of an auxiliary gas burner 29 which is positioned between the solar receiver 20 and the turbine 28. Namely, gas from the solar receiver 20 is supplied through a line 17 to a heat exchanger 27 in the furnace of the gas burner 29. The gas flow path continues along line 18 to the turbine 28. The figure shows valve configurations as they would be when the heat store is being used to drive the water/steam circuit. When the gas burner 29 is active, the valve positions will be as illustrated in FIG. 3 for the comparable first embodiment.

The second alteration is exchange of separate hot and cold tanks for a thermocline tank 130 in which all the liquid storage material is stored, with its heat being stratified naturally with the hotter material at the top and the colder material at the bottom, to provide a hot, top end 132 and a cold, bottom end 134. A line 92 is connected to the hot end 132 and a line 82 is connected to the cold end 134. Functionally, the operation is the same as with separate hot and cold tanks so is not described further. Further details of thermocline storage is described in Hermann et al.

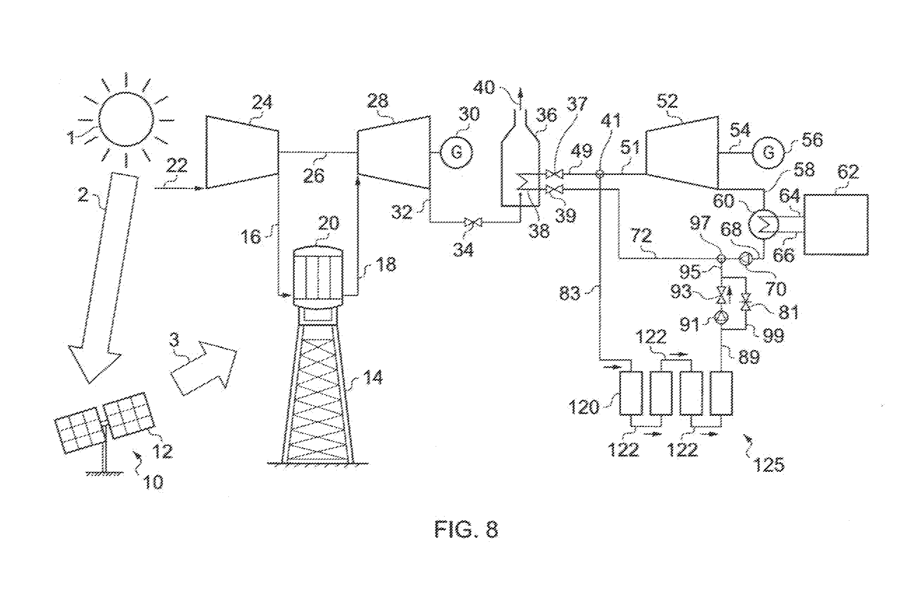

FIG. 8 is a schematic diagram of a combined cycle concentrated solar power station according to a fourth embodiment of the invention as configured for day time use.

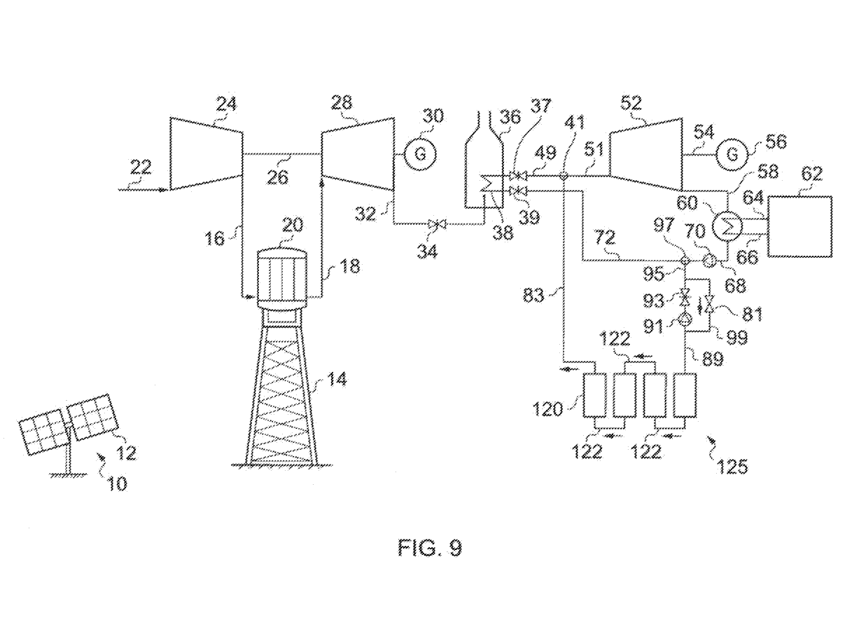

FIG. 9 shows the power station of FIG. 8 configured for night time use.

The power station of the fourth embodiment as illustrated in FIGS. 8 and 9 is described with reference to the power station of the first embodiment as illustrated in FIGS. 3 and 4. The reference numerals for corresponding components are kept the same between the first and fourth embodiments.

The fourth embodiment replaces the liquid medium heat storage system based on hot and cold tanks with a solid block heat storage. This is the only difference. This difference is evident in the lower right hand side of the figures in that the lines of pipes 83 and 89, which form a branch of the secondary cycle, connect to a solid heat block store 125 (instead of the first embodiment arrangement of a heat exchanger in thermal communication with the liquid medium).

FIG. 8 shows the power station in day time use during which steam is tapped off through the spur line 83 to the solid block heat storage 125. The solid block heat storage 125 comprises a bank of solid blocks 120 interconnected by pipes 122 with the flow direction being indicated in the figure by arrows. The solid blocks 120 may be made of concrete, for example, or a castable ceramic material. Steam therefore passes along line 83 and through the concrete blocks 120 thereby heating them. If will be appreciated that the concrete blocks will have multiple paths through them for the steam/water to provide sufficient surface area for good thermal transfer. In other words, the single pipe in the schematic illustration will in reality be multiple pipes running in parallel, preferably in a two dimensional distribution when viewed in cross-section. The paths may be formed by pipes embedded in the concrete, for example. At the outlet of the heat storage 125, connected to the line 89, the now condensed water will then flow further as in the first embodiment assisted by the pump 91 and feed back to the primary steam circuit at the junction 97.

FIG. 9 shows the power station of the fourth embodiment configured for night time use in which the flow direction in the spur line through the solid block heat storage 125 is reversed. Water flows into the spur at junction 97 and through open valve 81 and lines 99 and 89 into the first concrete block 120, and then the subsequent blocks, thereby converting the water to steam which is then fed to the steam turbine 52 via line 83, junction 41 and line 51.

Generally, for all the embodiments, routine variations may be made within the scope of the invention. For example, the numbers of pumps, placement of valves, and routing of pipe work may be varied. One example would be to use a single pump in the heat storage circuit with suitable valve settings and pipe routing to enable the single pump to act in both the required directions.

The first to third embodiments are based on liquid medium heat storage and the fourth embodiment is based on solid block heat storage. These two types of heat storage may be generically termed as sensible heat storage systems. In sensible heat storage systems the storage medium is heated up during charging and cooled down during discharging. Hence the storage is hot in the charged and cold in the discharged state.

The invention could also be implemented using latent heat storage systems. In latent heat storages the storage medium (a phase change medium) is molten during charging and frozen during discharging. Hence the storage medium is liquid in the charged and solid in the discharged state. An example phase change medium is an alkali nitrate salt such as NaNO₃, KNO₃.

The invention could also be implemented using chemical heat media such as metal oxide/metal, iron carbonate, calcium carbonate or magnesium oxide, in which heat is stored through the use of reversible endothermic chemical reactions.

1. A combined cycle power plant based on a primary cycle and a secondary cycle, the primary cycle comprising:
a) a compressor having a gas inlet and being operable to compress the gas received from the gas inlet;
b) a solar receiver arranged to receive compressed gas from the compressor as well as concentrated solar radiation, the solar receiver comprising a gas passageway through which the compressed gas is passed and which is in thermal communication with the concentrated solar radiation, thereby to heat the gas; and
c) a gas turbine through which the heated gas is expanded to generate electricity;
the secondary cycle based on a water/steam circuit in which is arranged:
d) a heat recovery steam generator having a heat exchanger arranged to generate steam from the heated expanded gas from the primary cycle output from the gas turbine;
e) a steam turbine through which steam is expanded to generate electricity; and
f) a condenser for condensing steam from the steam turbine;
further comprising:
g) a heat storage circuit including a heat storage material, the heat storage circuit being reconfigurable between first and second switching conditions, wherein in the first switching condition heat is transferable from the primary cycle to heat the heat storage material, and in the second switching condition heat is transferable from the heat storage material to the water/steam circuit in order to generate steam.

2. The power plant of claim 1, further comprising a heliostat arranged to concentrate solar radiation onto the solar receiver.

3. The power plant of claim 1, further comprising an auxiliary fossil fuel burner arranged in the primary cycle to heat and compress the gas as an alternative to the solar receiver, thereby providing a hybrid primary cycle.

4. The power plant of claim 1, wherein the solar receiver comprises a volumetric absorber arranged to receive the concentrated solar radiation and in thermal communication with the gas passageway.

5. The power plant of claim 1, wherein the heat storage material comprises one or more solid blocks arranged in thermal communication with the heat storage circuit.

6. The power plant of claim 1, wherein the heat storage material comprises a liquid contained in the heat storage circuit.

7. The power plant of claim 5, wherein the heat storage circuit comprises a heat exchanger which in the first switching condition provides thermal contact between the heat storage material and steam in the secondary cycle, thereby to heat the heat storage material.

8. The power plant of claim 6, wherein the heat storage circuit comprises a heat exchanger which in the first switching condition provides thermal contact between the liquid heat storage material and hot gas from the primary cycle, thereby to heat the liquid heat storage material.

9. The power plant of claim 6, wherein the liquid heat storage circuit further comprises a cold storage tank and a hot storage tank, wherein in the first switching condition liquid heat storage material passes from the cold storage tank to the hot storage tank, and in the second switching condition liquid heat storage material passes from the hot storage tank to the cold storage tank.

10. The power plant of claim 6, wherein the liquid heat storage circuit further comprises a thermocline storage tank having a hot end and a cold end, wherein in the first switching condition liquid heat storage material is taken from the cold end of the storage tank and returned to the hot end of the storage tank, and in the second switching condition liquid heat storage material is taken from the hot end of the storage tank and is returned to the cold end of the storage tank.

11. A combined cycle method of generating electricity utilizing a first thermodynamic cycle operating in a first temperature range in combination with a second thermodynamic cycle operating in a second temperature range lower than the first temperature range,
wherein the first thermodynamic cycle is based on:
a) directing solar radiation onto a solar receiver;
b) supplying compressed gas to the solar receiver to heat the gas; and
c) expanding the heated gas to generate electricity;
wherein the second thermodynamic cycle is based on:
d) heating steam;
e) expanding the steam to generate electricity;
f) passing the steam through a condenser to liquefy it into water;
g) supplying the water onward for re-heating into steam;
further comprising a first mode of use to be operated during periods when the first thermodynamic cycle is active comprising:
i) heating the water in the second thermodynamic cycle into steam using the expanded gas from the first thermodynamic cycle so that the first thermodynamic cycle drives the second thermodynamic cycle; and
ii) heating a heat storage material using either steam from the second thermodynamic cycle, or gas from the first thermodynamic cycle, and then retaining the heated heat storage material for later use;
and a second mode of use to be operated during periods when the first thermodynamic cycle is inactive comprising:
iii) heating the steam using the heat storage material that was heated in the first mode of use, thereby to drive the second thermodynamic cycle when the first thermodynamic cycle is inactive.

12. The method of claim 11, further comprising a second mode of use with an alternate first thermodynamic cycle, wherein an auxiliary fossil fuel burner is operated as an alternative heat source to drive the first thermodynamic cycle, wherein the alternate first thermodynamic cycle comprises:
a′) combusting fossil fuel in a burner;
b′) using heat from the burner to heat compressed gas; and
c′) expanding the heated gas to generate electricity.

13. The method of claim 11, wherein the solar receiver comprises a volumetric absorber arranged to receive the solar radiation and in thermal communication with the compressed gas.

14. The method of claim 11, wherein the heat storage material comprises one or more solid blocks.

15. The method of claim 11, wherein the heat storage material comprises a liquid.
